(19) United States
(12) Patent Application Publication
(10) Pub. No.: US 2011/0013868 A1
(43) Pub. Date: Jan. 20, 2011

(54) OPTICAL WAVEGUIDE FOR VISIBLE LIGHT

(76) Inventors: Kouji Suzumura, Ibaraki (JP); Atsushi Takahashi, Ibaraki (JP); Toshihiro Kuroda, Ibaraki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/808,548

(22) PCT Filed: Dec. 16, 2008
(86) PCT No.: PCT/JP2008/072832

§ 371 Date: Sep. 14, 2010

(30) Foreign Application Priority Data
Dec. 17, 2007 (JP) 2007-325147
Jan. 9, 2008 (JP) 2008-002147

(51) Int. Cl. G02B 6/26; G02B 6/10; G02B 6/32; G02B 6/34; G02B 6/02; G02B 6/27

(52) U.S. Cl. 385/32; 385/31; 385/33; 385/123; 385/37

(57) ABSTRACT

The present invention relates to an optical waveguide for visible light guide containing an optical waveguide layer, at least one light entering part and at least one light exiting part, the light entering part and the light exiting part being disposed not adjacent to each other, that can be easily reduced in size and reduced in thickness, can be formed or the like on a substrate, and can be used for an illumination purpose, and also provides a flexible optical waveguide for visible light guide that emits light partly, is flexible to enable use in a bent state, and can be installed in a small gap in a small-sized electronic apparatus.

### TECHNICAL FIELD

The present invention relates to an optical waveguide and a flexible optical waveguide that are favorable for visible light guide.

### BACKGROUND ART

An optical waveguide is a circuit that is formed by providing an optical path on a substrate by utilizing a difference in refractive index of light, thereby guiding an optical signal, in which an optical signal can be guided to a circuit formed on a substrate as similar to a flow of electrons in an electric circuit, by utilizing a difference in refractive index or the like. An optical waveguide having a planar structure is different in structure from an optical fiber in a fiber form.

As stated herein, an optical waveguide and an optical fiber are used for a communication purpose (see, for example, Patent Document 1).

For illuminating a liquid crystal display device of a mobile phone and the like, a light guide plate is used for conducting light emitted from a light source. A light guide plate has a planar form with a substantially plate-like shape, and has a light entering part disposed on one side surface and a polarizing pattern formed over the entire lower surface with plural polarizing pattern devices for reflecting or polarizing light entering on the light entering part toward a light exiting part. The light exiting part is formed over the entire upper surface opposite to the surface having the polarizing pattern formed thereon. Accordingly, the light entering part and the light exiting part are generally adjacent to each other (see, for example, Patent Document 2).

Patent Document 3 proposes an optical cable for illumination containing optical fibers as a purpose other than communication. Furthermore, Patent Document 4 proposes an illumination apparatus containing an optical fiber having a core part transmitting light and a cladding part surrounding the core part, the cladding part containing a dispersoid dispersed thereinside. The dispersoid emits light through photoexcitation with light leaked from the core part, and the light emission is used as an illumination source.

[Patent Document 1] JP-A-2001-74957

[Patent Document 2] Japanese Patent No. 3,151,830

[Patent Document 3] JP-A-2000-147263

[Patent Document 4] JP-A-2004-287067

### DISCLOSURE OF THE INVENTION

However, upon using the optical cable for illumination containing optical fibers for illumination, plural cables are necessarily bundled and mounted with an attachment, thereby providing a problem that the assembly is difficultly reduced in size.

The light guide plate has a light exiting part that is not disposed at a particular position, and has a problem that it is difficultly reduced in size.

Accordingly, such an illumination apparatus is demanded that can be easily reduced in size and reduced in thickness and can be formed or the like on a substrate, and furthermore such an illumination apparatus is demanded that can be installed in a small gap in a small-sized electronic apparatus.

In view of the aforementioned problems, an object of the present invention is to provide an optical waveguide for visible light guide that can be easily reduced in size and reduced in thickness, can be formed or the like on a substrate, and can be used for an illumination purpose. Another object of the present invention is to provide a flexible optical waveguide for visible light guide that emits light partly, is flexible to enable use in a bent state, and can be installed in a small gap in a small-sized electronic apparatus.

As a result of earnest investigations made by the inventors, it has been found that the aforementioned problems are solved by disposing a light entering part (light incident part) and a light exiting part (light emission part) of the optical waveguide at particular positions, and more preferably by imparting a particular structure to a particular part between a light entering part (light incident part) and a light exiting part (light emission part) of the optical waveguide.

The present invention includes (1) an optical waveguide for visible light guide containing an optical waveguide layer, at least one light entering part and at least one light exiting part, the light entering part and the light exiting part being disposed not adjacent to each other; (2) the optical waveguide for visible light guide according to the item (1), wherein the optical waveguide layer has a core layer that is partially or entirely covered with a cladding layer, and has at least one selected from a taper structure, a stepwise structure, a relief structure and a discontinuous core structure with the core layer as a structure for emitting light to the light exiting part; and (3) the optical waveguide for visible light guide according to the item (1), which is a flexible optical waveguide in a strip form.

According to the present invention, such an optical waveguide for visible light guide can be provided that can be easily reduced in size and reduced in thickness, can be formed or the like on a substrate, and can be used for an illumination purpose. Furthermore, such a flexible optical waveguide for visible light guide can be provided that emits light partly, is flexible to enable use in a bent state, and can be installed in a small gap in a small-sized electronic apparatus. Moreover, a reflection mirror and the like can be easily produced, and light emission in the vertical direction is enabled.

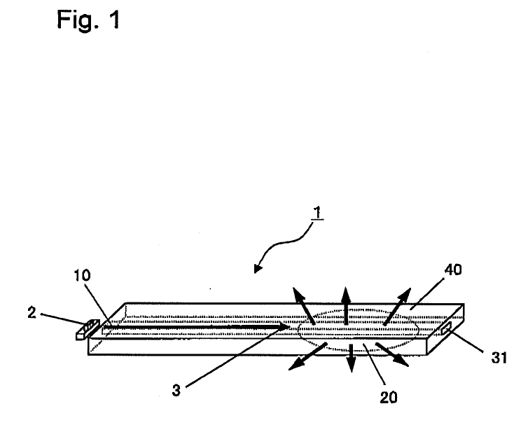

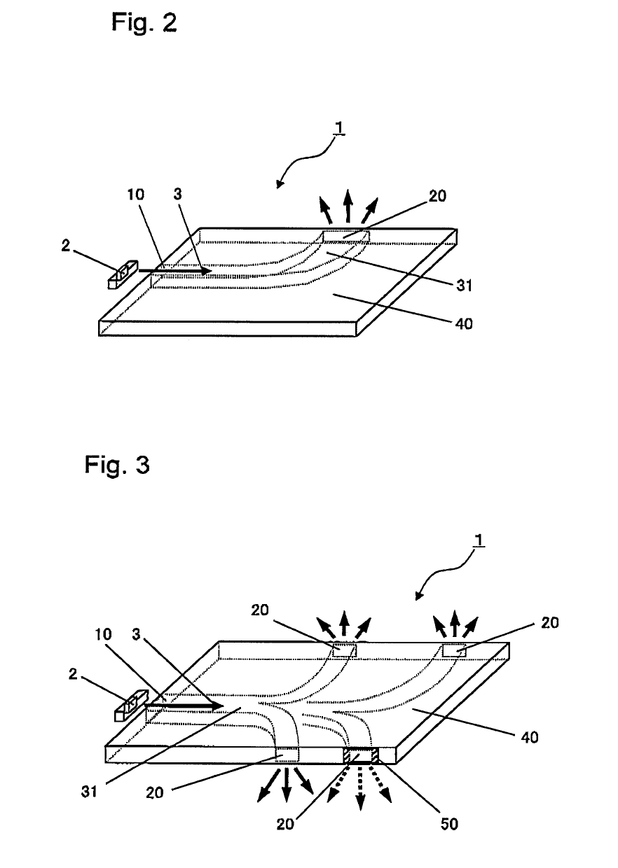

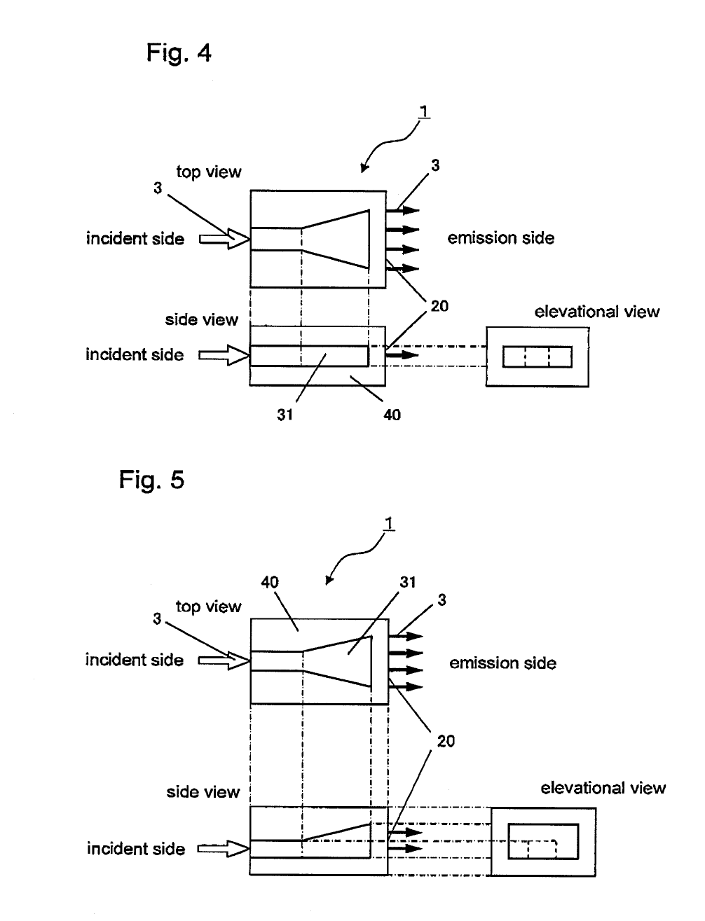

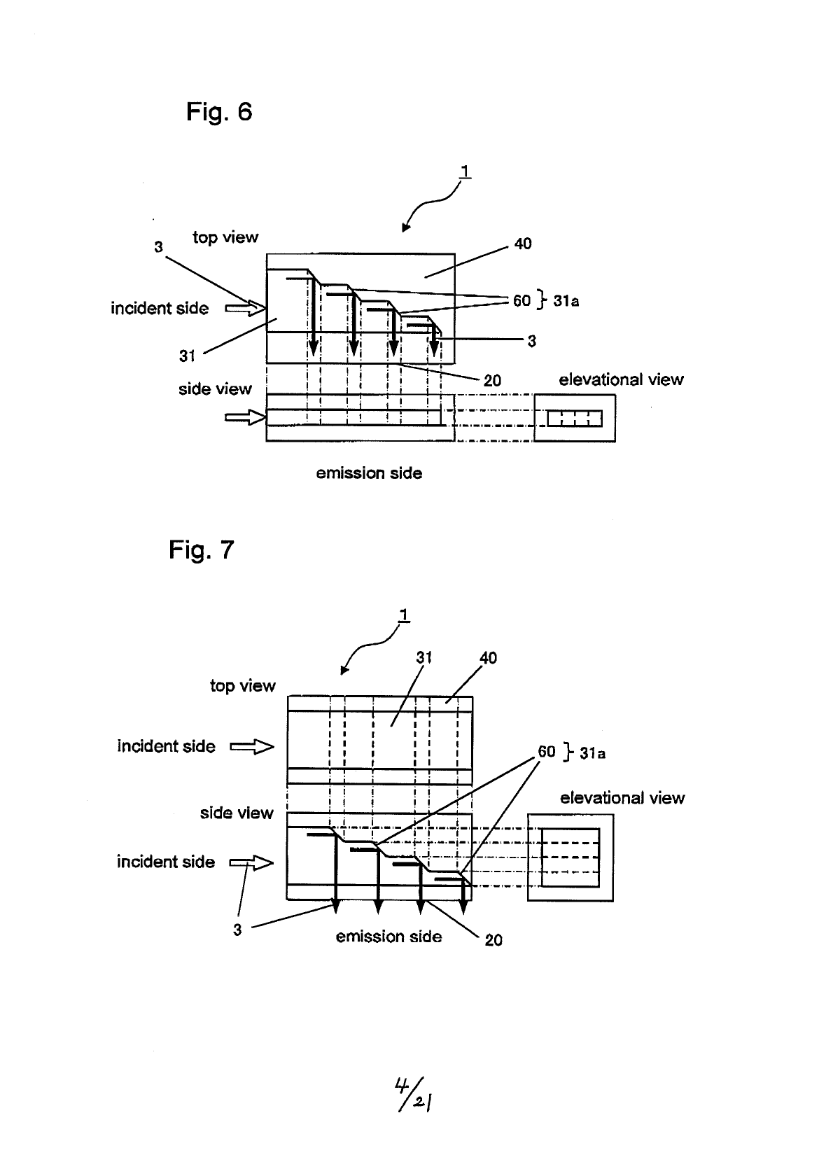

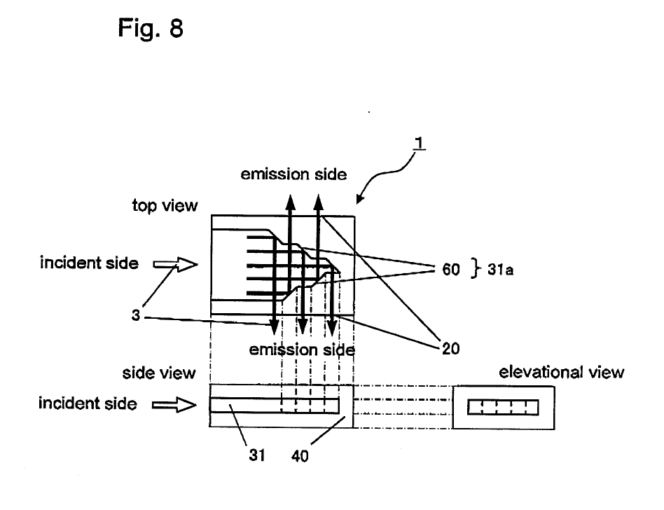

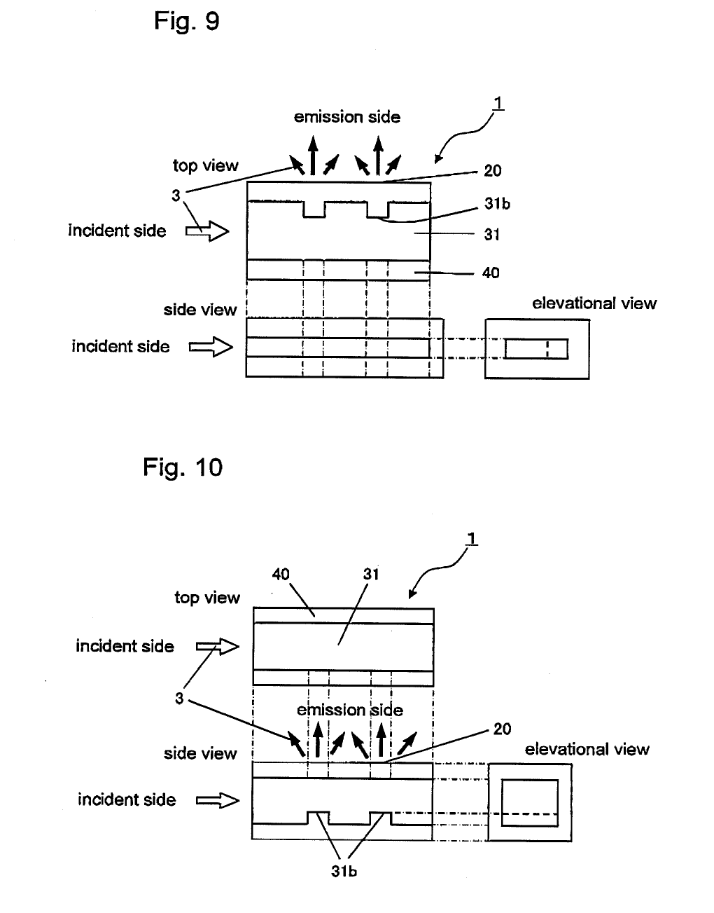

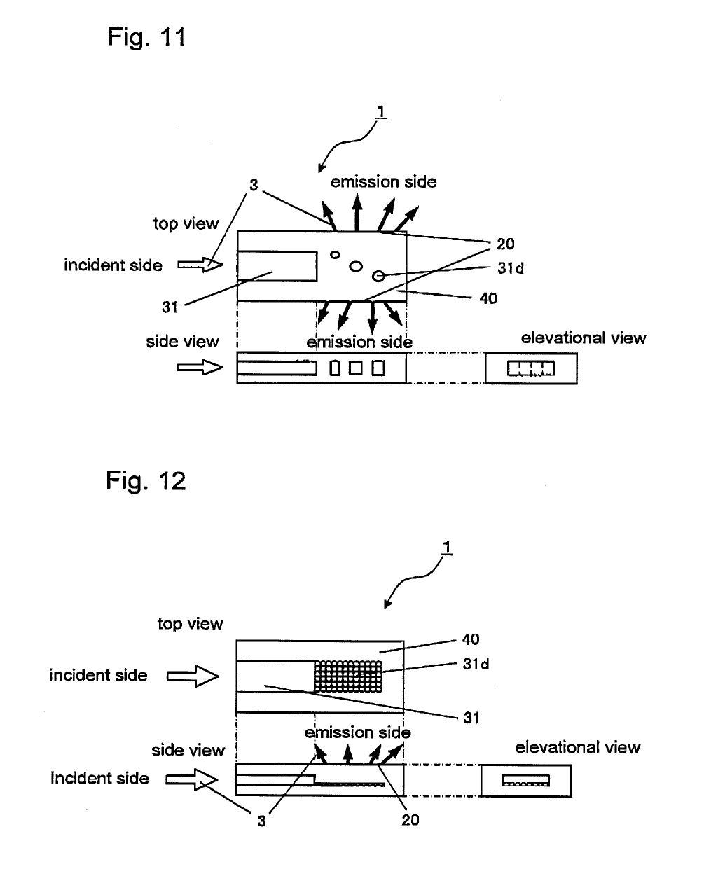

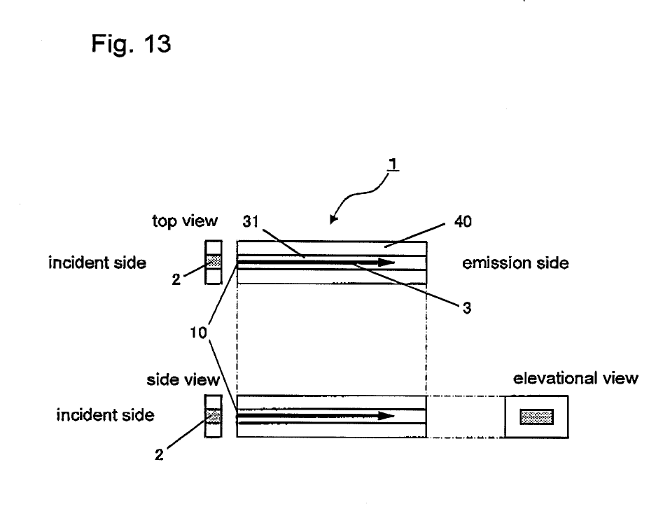

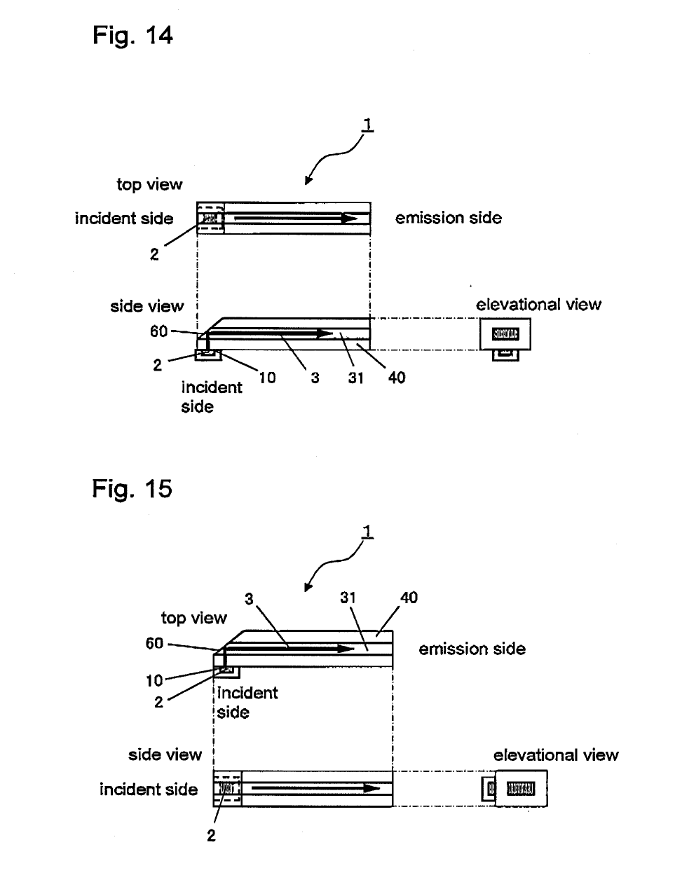

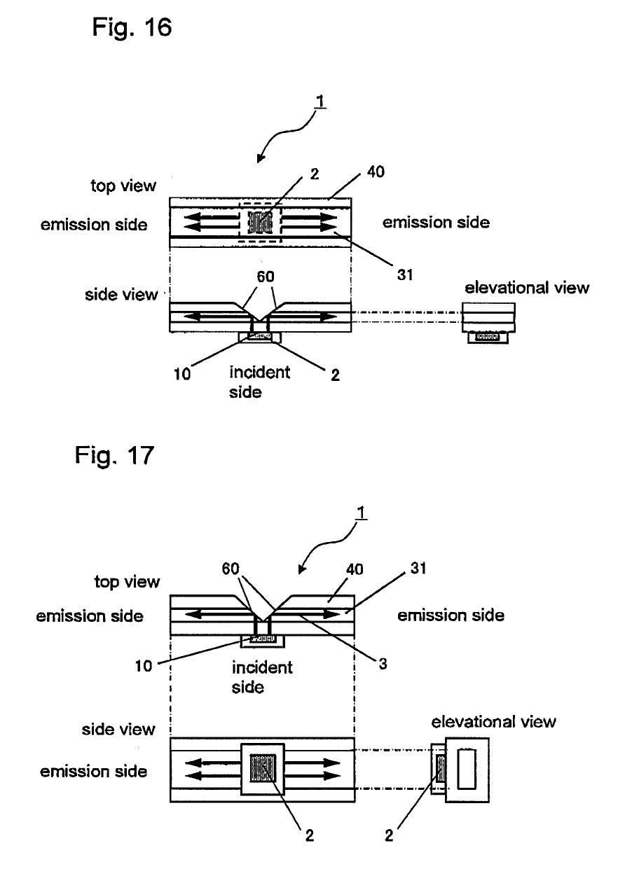

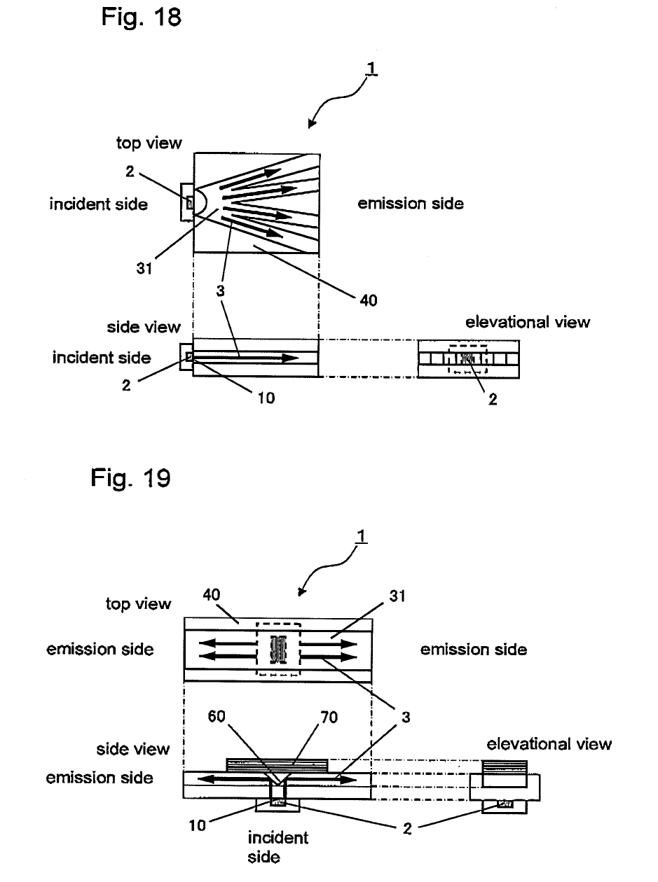

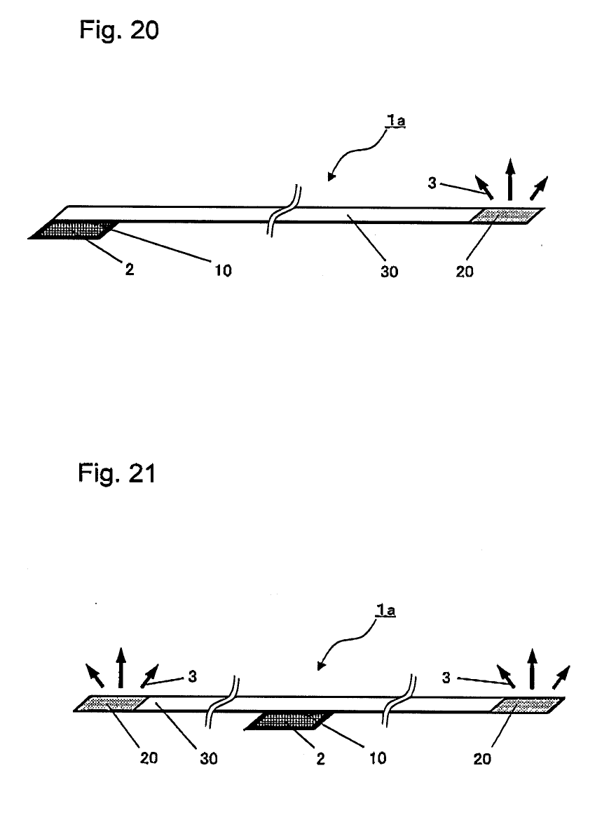

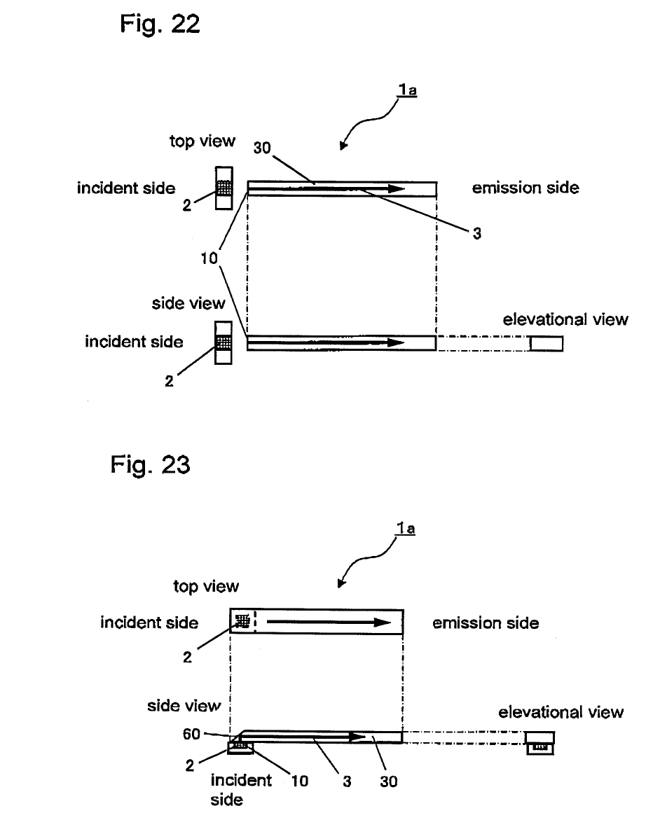

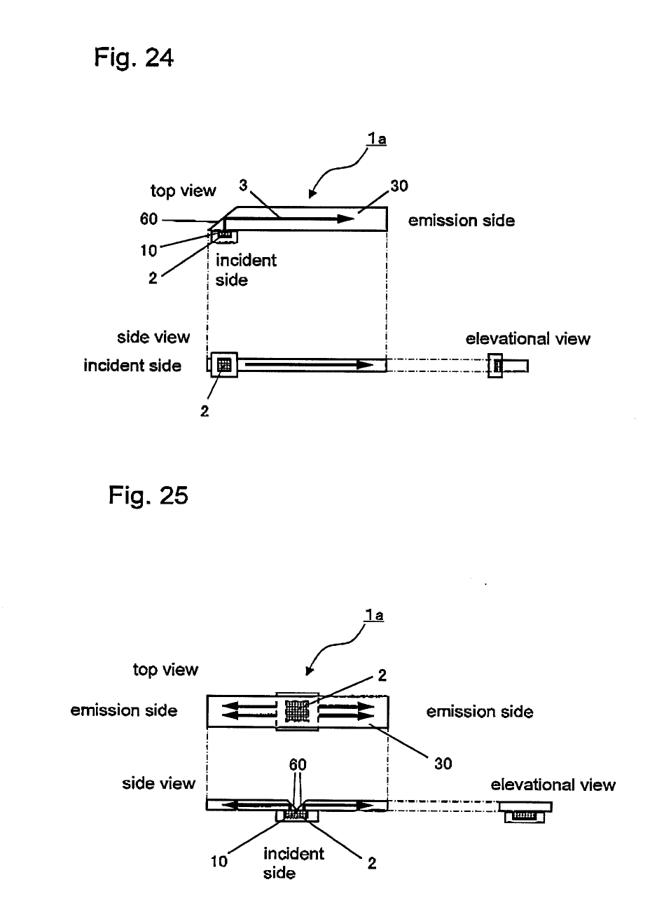

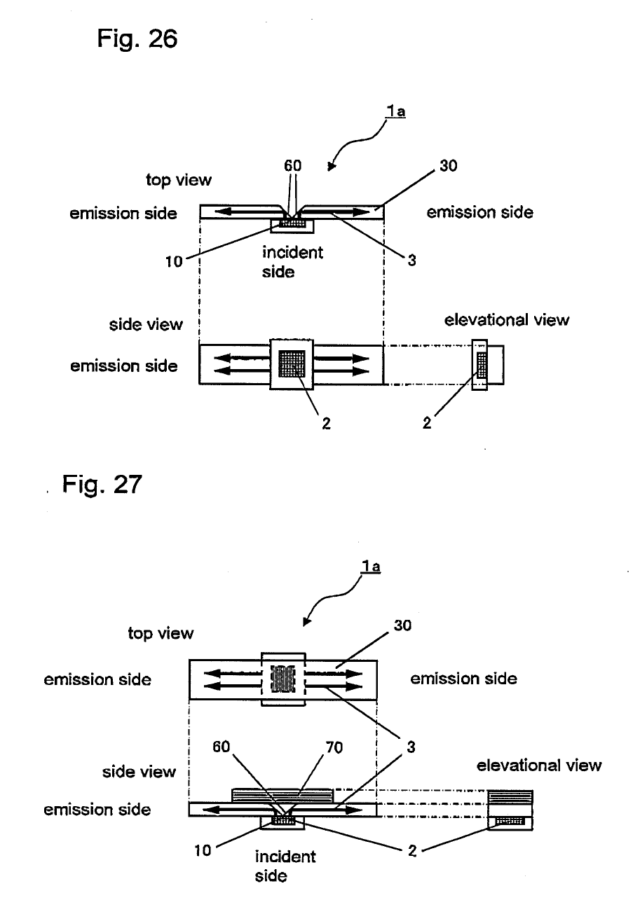

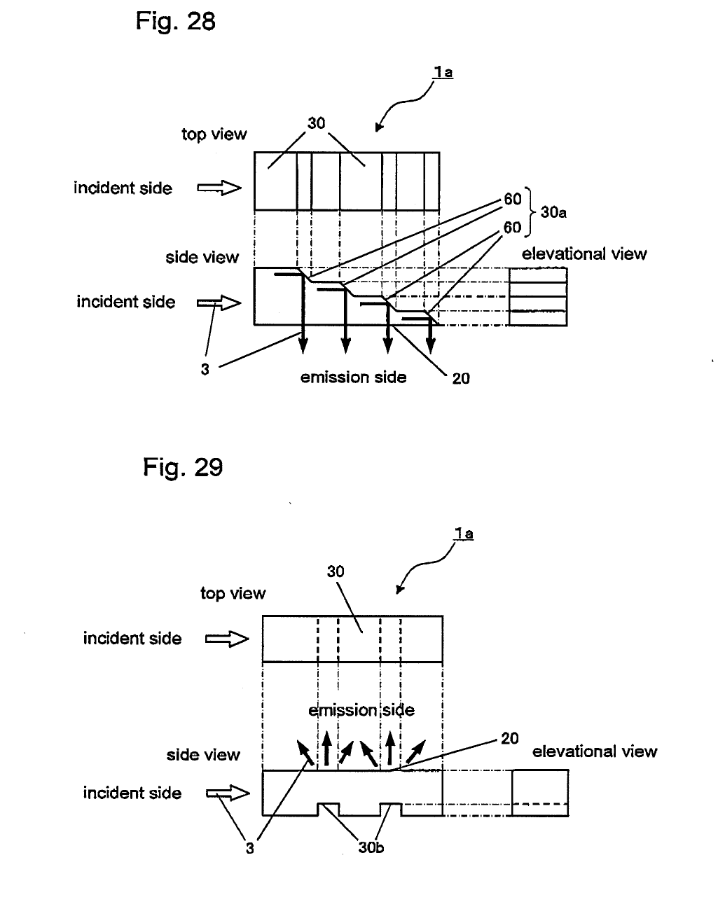

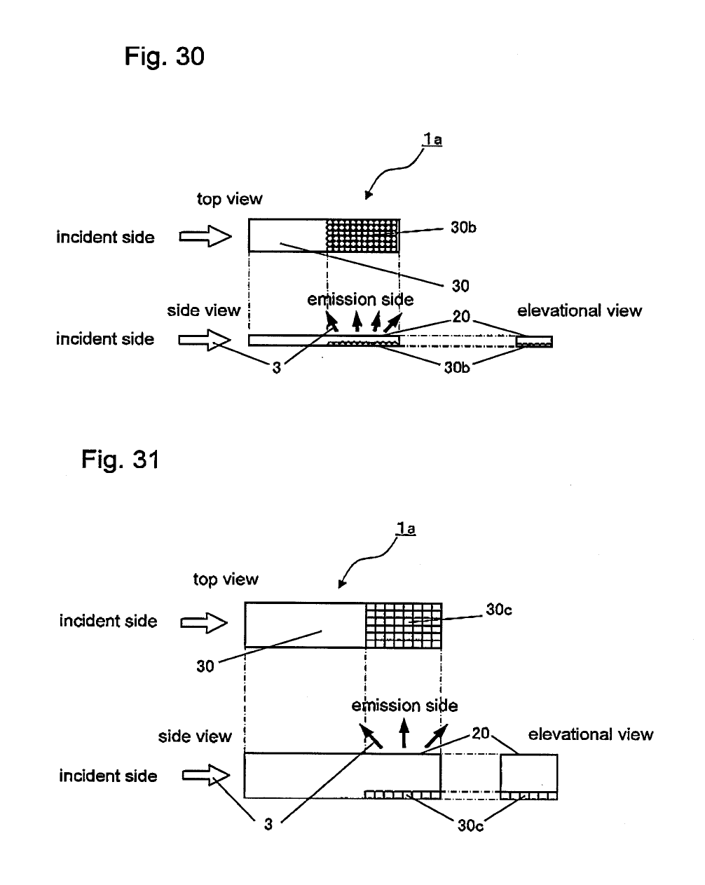

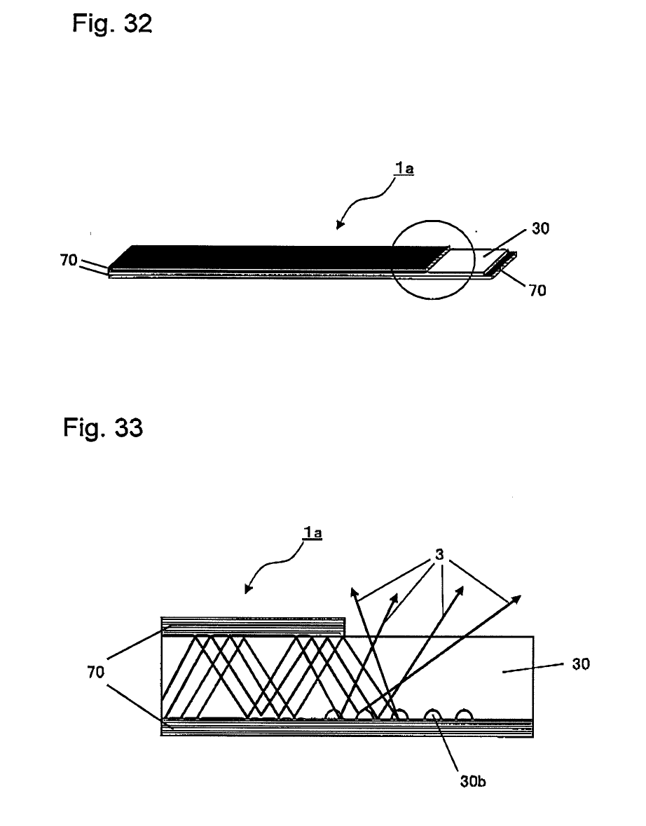

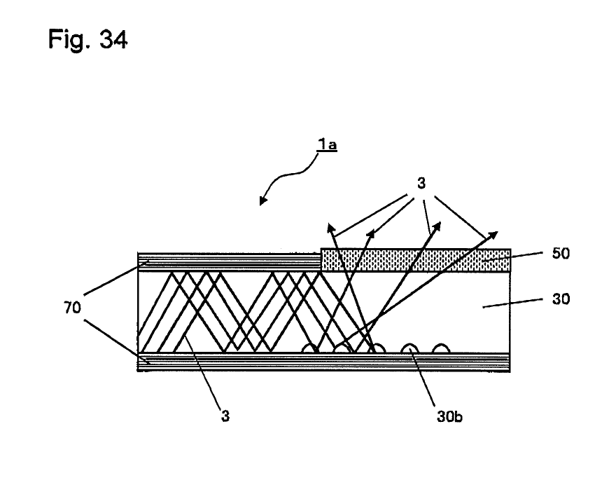

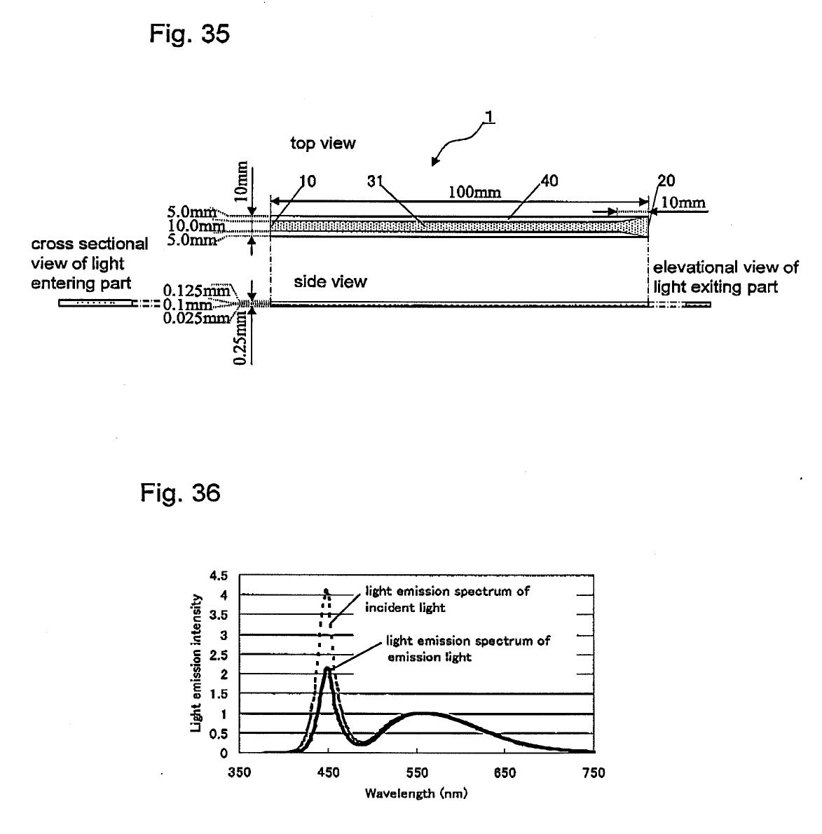

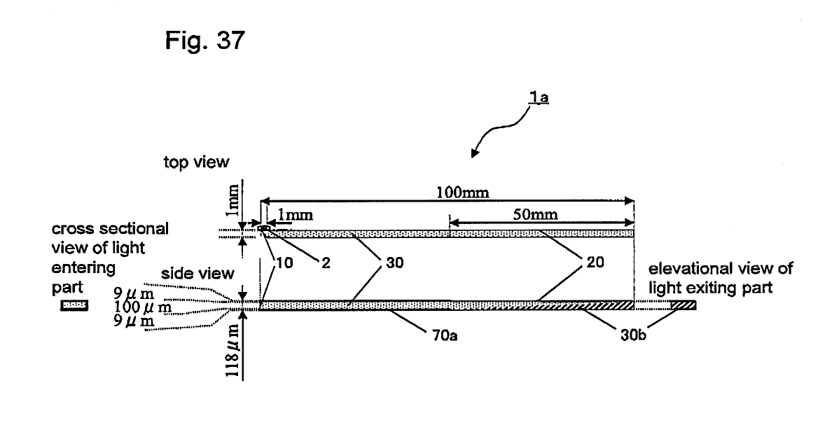

### BRIEF DESCRIPTION OF THE DRAWINGS

[FIG. 1] The figure is a schematic illustration showing an example of an optical waveguide for visible light guide according to the present invention.

[FIG. 2] The figure is a schematic illustration showing another example of an optical waveguide for visible light guide according to the present invention.

[FIG. 3] The figure is a schematic illustration showing still another example of an optical waveguide for visible light guide according to the present invention.

[FIG. 4] The figure is a partial schematic illustration showing an example of a taper structure of a core layer of an optical waveguide for visible light guide according to the present invention.

[FIG. 5] The figure is a partial schematic illustration showing an example of a taper structure of a core layer of an optical waveguide for visible light guide according to the present invention.

[FIG. 6] The figure is a partial schematic illustration showing an example of a stepwise structure of a core layer of an optical waveguide for visible light guide according to the present invention.

[FIG. 7] The figure is a partial schematic illustration showing an example of a stepwise structure of a core layer of an optical waveguide for visible light guide according to the present invention.

[FIG. 8] The figure is a partial schematic illustration showing an example of a stepwise structure of a core layer of an optical waveguide for visible light guide according to the present invention.

[FIG. 9] The figure is a partial schematic illustration showing an example of a relief structure of a core layer of an optical waveguide for visible light guide according to the present invention.

[FIG. 10] The figure is a partial schematic illustration showing an example of a relief structure of a core layer of an optical waveguide for visible light guide according to the present invention.

[FIG. 11] The figure is a partial schematic illustration showing an example of a discontinuous core structure of a core layer of an optical waveguide for visible light guide according to the present invention.

[FIG. 12] The figure is a partial schematic illustration showing an example of a discontinuous core structure of a core layer of an optical waveguide for visible light guide according to the present invention.

[FIG. 13] The figure is a partial schematic illustration showing an example of a light entering part of an optical waveguide for visible light guide according to the present invention.

[FIG. 14] The figure is a partial schematic illustration showing another example of a light entering part of an optical waveguide for visible light guide according to the present invention.

[FIG. 15] The figure is a partial schematic illustration showing still another example of a light entering part of an optical waveguide for visible light guide according to the present invention.

[FIG. 16] The figure is a partial schematic illustration showing still another example of a light entering part of an optical waveguide for visible light guide according to the present invention.

[FIG. 17] The figure is a partial schematic illustration showing still another example of a light entering part of an optical waveguide for visible light guide according to the present invention.

[FIG. 18] The figure is a partial schematic illustration showing still another example of a light entering part of an optical waveguide for visible light guide according to the present invention.

[FIG. 19] The figure is a partial schematic illustration showing still another example of a light entering part of an optical waveguide for visible light guide according to the present invention.

[FIG. 20] The figure is a schematic illustration showing an example of a flexible optical waveguide for visible light guide according to the present invention.

[FIG. 21] The figure is a schematic illustration showing another example of a flexible optical waveguide for visible light guide according to the present invention.

[FIG. 22] The figure is a partial schematic illustration showing an example of a light entering part of a flexible optical waveguide for visible light guide according to the present invention.

[FIG. 23] The figure is a partial schematic illustration showing another example of a light entering part of a flexible optical waveguide for visible light guide according to the present invention.

[FIG. 24] The figure is a partial schematic illustration showing still another example of a light entering part of a flexible optical waveguide for visible light guide according to the present invention.

[FIG. 25] The figure is a partial schematic illustration showing still another example of a light entering part of a flexible optical waveguide for visible light guide according to the present invention.

[FIG. 26] The figure is a partial schematic illustration showing still another example of a light entering part of a flexible optical waveguide for visible light guide according to the present invention.

[FIG. 27] The figure is a partial schematic illustration showing still another example of a light entering part of a flexible optical waveguide for visible light guide according to the present invention.

[FIG. 28] The figure is a partial schematic illustration showing an example of a stepwise structure of an optical waveguide layer of a flexible optical waveguide for visible light guide according to the present invention.

[FIG. 29] The figure is a partial schematic illustration showing an example of a relief structure of an optical waveguide layer of a flexible optical waveguide for visible light guide according to the present invention.

[FIG. 30] The figure is a partial schematic illustration showing an example of a relief structure of an optical waveguide layer of a flexible optical waveguide for visible light guide according to the present invention.

[FIG. 31] The figure is a partial schematic illustration showing an example of a mesh structure of an optical waveguide layer of a flexible optical waveguide for visible light guide according to the present invention.

[FIG. 32] The figure is a partial schematic illustration showing an example of a flexible optical waveguide for visible light guide according to the present invention, in which the upper surface and the lower surface of the optical waveguide layer except for the light exiting part are covered with a light reflection layer.

[FIG. 33] The figure is a partial schematic illustration showing an example of a flexible optical waveguide for visible light guide according to the present invention, in which the circled area in FIG. 32 is enlarged.

[FIG. 34] The figure is a partial schematic illustration showing another example of a flexible optical waveguide for visible light guide according to the present invention, in which the circled area in FIG. 32 is enlarged.

[FIG. 35] The figure is a schematic illustration showing an example of an optical waveguide having a taper structure according to the present invention, the optical waveguide being produced in Example 12.

[FIG. 36] The figure is a schematic illustration showing a light emission spectrum where white LED light is guided with an optical waveguide according to the present invention (the optical waveguide of Examples 12 and 14).

[FIG. 37] The figure is a schematic illustration showing an example of a flexible optical waveguide for visible light guide having a relief structure according to the invention, the optical waveguide being produced in Example 14.

### EXPLANATION OF SYMBOLS

1 optical waveguide for visible light guide
1a flexible optical waveguide for visible light guide
2 light source
3 light
10 light entering part
20 light exiting part
30 optical waveguide layer
31 core layer
30a, 31a stepwise structure
30b, 31b relief structure
30c mesh structure
31d discontinuous core structure
40 cladding layer
50 colored film
60 reflection mirror
70 light reflection layer
70a copper foil

### BEST MODE FOR CARRYING OUT THE INVENTION

The optical waveguide for visible light guide according to the present invention has an optical waveguide layer, at least one light entering part and at least one light exiting part, and the light entering part and the light exiting part are disposed not adjacent to each other. In the optical waveguide for visible light guide according to the present invention, the light entering part and the light exiting part are disposed not adjacent to each other, whereby the light entering part and the light exiting part can be disposed at the desired positions, and light can be emitted partly.

A first preferred embodiment of the present invention is the optical waveguide for visible light guide, in which the optical waveguide layer has a core layer that is partially or entirely covered with a cladding layer, and has at least one selected from a taper structure, a stepwise structure, a relief structure and a discontinuous core structure with the core layer as a structure for emitting light to the light exiting part. Each of these structures with the core layer is a structure for emitting light in a desired shape from a desired position.

A second preferred embodiment of the present invention is the flexile optical waveguide, in which the optical waveguide for visible light guide is in a strip form. Owing to the flexibility and the strip form, the optical waveguide can be used in a bent state and thus can be installed in a small gap in a small-sized electronic apparatus.

The optical waveguide layer in the second embodiment corresponds to the core layer in the core layer/cladding layer of the optical waveguide for communication. The flexible optical waveguide for visible light guide in the second embodiment has a basic structure that has only an optical waveguide layer guiding light without a cladding layer. Owing to the absence of a cladding layer, the flexible optical waveguide for visible light guide can be further reduced in size and reduced in thickness.

In the present invention, the light entering part (light incident part) means an outer surface of a portion of the optical waveguide for visible light guide, on which light is incident from a light source. There are not only a case where the light entering part is on the outer surface of the core layer, but also a case where it is on the outer surface of the cladding layer, in the first embodiment. This is because there is a case where light is incident on the core layer through the cladding layer.

In the present invention, the light exiting part (light emission part) means an outer surface of a portion of the optical waveguide for visible light guide, from which light is emitted. As similar to the light entering part, there are not only a case where the light exiting part is on the outer surface of the core layer, but also a case where it is on the outer surface of the cladding layer, in the first embodiment.

It is preferred that the optical waveguide for visible light guide of the present invention can guide light having a wavelength of from 350 to 800 nm. This is because the optical waveguide is used for illumination.

It is also preferred that the optical waveguide for visible light guide of the present invention is an optical waveguide for guiding light having a wavelength of from 350 to 800 nm, in which the light emission intensity ratio of the maximum peak in a light emission spectrum in a wavelength range of from 420 to 500 nm between the incident light and the emission light has a relationship (incident light peak intensity)/(emission light peak intensity)-1/1 to 1/0.3. This is because excellent visibility for illumination can be obtained when the ratio of the height of the maximum peak is in the range.

It is preferred that the optical waveguide for visible light guide of the present invention has an area of the light exiting part of from 0.0025 to 100 mm². This is because an illuminance for illumination can be sufficiently secured with the range. It is preferred that in the first embodiment, the core layer has a thickness of from 0.05 to 2.0 mm owing to the same reason.

In the second embodiment of the present invention, the total area of the light exiting part is preferably 70% or less, and more preferably from 20 to 70%, of the total area of the surface that has the maximum surface area of the flexible optical waveguide. According to the structure, the luminance of the light emitted can be increased.

In the second embodiment of the present invention, for emitting light in a desired shape from a desired position, the optical waveguide layer preferably has at least one selected from a stepwise structure, a relief structure and a mesh structure, as a structure for emitting light to the light exiting part. These structures may be formed either inside the optical waveguide layer or at an interface thereof.

It is preferred that the flexible optical waveguide for visible light guide according to the second embodiment of the present invention has the light entering part and the light exiting part that are disposed on the same surface or opposing surfaces of the optical waveguide layer. The case includes a case where the light entering part and the light exiting part are each independently disposed on the upper surface or the lower surface of the optical waveguide layer and a case where the light entering part and the light exiting part are each independently disposed on the side surface of the optical waveguide layer, and the former case is more preferred. The area of the light entering part and the area of the light exiting part can be made larger on the upper surface or the lower surface of the optical waveguide layer than the side surface thereof, thereby increasing the luminance of the light emitted.

In the second embodiment of the present invention, one of the light entering part and the light exiting part may be disposed on the side surface of the optical waveguide layer, and the other may be disposed on the upper surface or the lower surface of the optical waveguide layer. The case includes a case where the light entering part is disposed on the upper surface or the lower surface of the optical waveguide layer whereas the light exiting part is disposed on the side surface of the optical waveguide layer and a case where the light entering part is disposed on the side surface of the optical waveguide layer whereas the light exiting part is disposed on the upper surface or the lower surface of the optical waveguide layer. In the former case, the area of the light entering part can be made larger on the upper surface or the lower surface of the optical waveguide layer than the side surface thereof, thereby increasing the luminance of the light emitted, and in the later case, the area of the light exiting part can be made larger, both of which may be selected arbitrarily depending on the demanded specification and the design of illumination.

In the present invention, The flexible optical waveguide for visible light guide according to the second embodiment is preferably in a strip form, in which the ratio length/width (the ratio of length divided by width) is preferably from 10 to 50,000, and more preferably from 10 to 1,000. The length of the flexible optical waveguide is preferably from 10 to 500 mm, and more preferably from 50 to 200 mm; the width of the flexible optical waveguide is preferably from 0.01 to 5 mm, and more preferably from 0.1 to 5 mm; and the thickness of the flexible optical waveguide is preferably from 10 to 500 μm, and more preferably from 50 to 300 μm. This is because the narrow and thin structure imparts flexibility and enables installation in a small gap in a small-sized electronic apparatus. Furthermore, the optical waveguide may have a structure where at least a part of the light exiting part is bent, whereby the optical waveguide can be installed in a bent small gap. This is also because the luminance of the light can be increased with the narrow structure.

The present invention will be described below with reference to the drawings.

FIG. 1 is a schematic illustration showing an example of an optical waveguide for visible light guide 1 according to the first embodiment of the present invention. In the optical waveguide for visible light guide 1 shown in FIG. 1, light 3 incident from a light source 2 through a light entering part 10 (the arrow shows the traveling direction of the light) travels in a core layer 31 and exits from a light exiting part 20 to the outside of the optical waveguide for visible light guide 1. In the case where plural light sources 2 are present or in the case where only a single light source 2 is present but is large, plural light entering parts 10 may be present. The core layer 31 may be formed into an arbitrary shape, thereby designing arbitrarily the illumination area and the illumination direction of the light. Specifically, the light exiting part 20 is not limited to the front surface part of the optical waveguide for visible light guide 1 opposite to the light source 2, but may be provided on the side surface part, the upper surface part and/or the lower surface part of the optical waveguide for visible light guide 1, as shown in FIG. 1.

The optical waveguide for visible light guide 1 of the present invention has a structure, in which the core layer 31 that is partially or entirely covered with a cladding layer 40. By covering the core layer 31 with the cladding layer 40, the light can pass through the core layer 31 to irradiate only a necessary portion, and the core layer 31 can have high reliability (for example, heat resistance, moisture resistance and strength).

FIG. 2 is a schematic illustration showing another example of an optical waveguide for visible light guide 1 according to the first embodiment of the present invention. FIG. 2 shows the case where light from a light source 2 is incident on one light entering part 10 and exits from one light exiting part 20, in which a core layer 31 covered on both side surface parts with a cladding layer 40 is curved in one plane to form the light exiting part 20 on the side surface part of the optical waveguide for visible light guide 1. The width of the core layer 31 may be expanded toward the light exiting part 20 to enlarge the light exiting part 20, thereby increasing the illumination area. The curvature radius R for curving the core layer 31 in one plane preferably exceeds 2 mm, and more preferably exceeds 5 mm. The light may be leaked to the cladding layer 40 when the core layer is curved sharply.

FIG. 3 is a schematic illustration showing another example of an optical waveguide for visible light guide 1 according to the first embodiment of the present invention. FIG. 3 shows the case where light 3 from a light source 2 is incident on one light entering part 10 and exits from plural light exiting parts 20, in which a core layer 31 covered on both side surfaces thereof with a cladding layer 40 is branched to right and left in one plane, the straight part of the core layer 31 is further branched to right and left in one plane, and the branches are each curved to form four light exiting parts 20 on the side surfaces of the optical waveguide for visible light guide 1. Plural light sources 2 may be used depending on necessity. A colored film 50 may be attached to the specific light exiting part 20 depending on necessity. The use of colored films with various colors variously changes the color of light emitted to provide design effect. A color filter, a polarizing filter or a coating layer containing a dye or a pigment may be attached thereto instead of the colored film 50. The attached position is not limited to the light exiting part 20 and may be the light entering part 10.

Structures for emitting light to a light exiting part 20 of an optical waveguide for visible light guide 1 according to the first embodiment of the present invention will be described with reference to FIGS. 4 to 12. FIGS. 4 to 12 each are a partial schematic illustration, in which a light entering part 10 is not shown therein.

FIGS. 4 and 5 are each a partial schematic illustration showing an example of a taper structure of a core layer of an optical waveguide for visible light guide according to the first embodiment of the present invention. In FIG. 4, the core layer 31 has a taper structure, in which the core layer is expanded in the horizontal direction (i.e., the directions toward the side surfaces) in one plane from the incident side to the emission side, whereby light 3 is diffused in the horizontal direction. The diffused light 3 exits from the light exiting part 20.

In FIG. 5, on the other hand, the core layer 31 has a taper structure, in which the core layer is expanded in the upward direction (i.e., the direction toward the upper surface) and the horizontal direction (i.e., the directions toward the side surfaces), whereby light 3 is diffused in the upward direction and the horizontal direction (i.e., the directions toward the side surfaces) and exits from the light exiting part 20.

In FIGS. 4 and 5, a cladding layer is present between the light exiting part 20 and the core layer 31, but the core layer having a taper structure may be connected directly to the light exiting part, and in this case, light having a shape that substantially agree with the core shape can be emitted. The case where a cladding layer is present between the light exiting part 20 and the core layer 31 as in FIGS. 4 and 5 is advantageous in moisture resistance and heat resistance and thus can emit light that is further diffused, and the structures are preferably selected corresponding to the purpose.

FIGS. 6 to 8 are each a partial schematic illustration showing an example of a stepwise structure of a core layer of an optical waveguide for visible light guide 1 according to the first embodiment of the present invention. In FIG. 6, a stepwise structure 31a in the horizontal direction (i.e., the direction toward the side surface) of a core layer 31 forms reflection mirrors 60 by each of the steps of the stepwise structure, and light 3 is reflected by each of the reflection mirrors 60 in the horizontal direction (i.e., the direction toward the side surface) to form plural branches of the light 3 in the horizontal direction (i.e., the direction toward the side surface).

In FIG. 7, a stepwise structure 31a in the downward direction (i.e., the direction toward the lower surface) of a core layer 31 forms reflection mirrors 60 by each of the steps of the stepwise structure, and light 3 is reflected by each of the reflection mirrors 60 in the downward direction (i.e., the direction toward the lower surface) to form plural branches of the light 3 in the downward direction (i.e., the direction toward the lower surface).

In FIG. 8, a composite stepwise structure 31a in the horizontal directions (i.e., the directions toward both the side surfaces) of a core layer 31 forms reflection mirrors 60 by each of the steps of the stepwise structure. Light 3 is reflected by each of the reflection mirrors 60 in the horizontal directions (i.e., the directions toward both the side surfaces) to form plural branches of the light 3 in the horizontal directions (i.e., the directions toward both the side surfaces).

The light 3 exits from the light exiting part 20 on the side Surface in FIG. 6, from the light exiting part 20 on the lower surface in FIG. 7, and from the light exiting parts 20 on both the right and left side surfaces in FIG. 8.

FIGS. 9 and 10 are each a partial schematic illustration showing an example of a relief structure of a core layer of an optical waveguide for visible light guide according to the first embodiment of the present invention. In FIG. 9, the core layer 31 has a relief structure 31b on the side surface thereof, and light 3 is diffused in the horizontal direction (i.e., the direction toward the side surface) and emitted from a light exiting part 20 on the side surface.

In FIG. 10, the core layer 31 has a relief structure 31b on the lower surface thereof, and light 3 is diffused in the upward direction (i.e., the direction toward the upper surface) and emitted from a light exiting part 20 on the upper surface.

FIGS. 11 and 12 are each a partial schematic illustration showing an example of a discontinuous core structure of a core layer of an optical waveguide for visible light guide 1 according to the first embodiment of the present invention. In FIG. 11, a discontinuous core 31d is present at a position that is on an extended line from the core layer 31 and is remote from the core layer 31, and light 3 is diffused by the discontinuous core 31d to a wide range in the horizontal directions. According to the structure, a wide area on the side surface forms a light exiting part 20. In the example shown in FIG. 11, the discontinuous core 31d has a columnar shape, and the present invention includes various shapes in addition to the columnar shape. The size and the distance of arrangement vary depending on the necessary illuminance and the like.

In FIG. 12, a discontinuous core 31d with numerous hemispheric shapes is present at a position that is on an extended line from the core layer 31 and is remote from the core layer 31 with the hemispheric surface directed upward to form a light scattering layer, and light 3 is diffused by the discontinuous core 31d in the upward direction (i.e., the direction toward the upper surface) and emitted from a light exiting part 20 on the upper surface.

The optical waveguide for visible light guide 1 that has various illumination patterns can be produced by providing or combining the taper structure, the stepwise structure, the relief structure and/or the discontinuous core structure mentioned above in the light entering part 10 and/or the light exiting part 20 of the core layer 31, and/or the core layer 31 between the light entering part 10 and the light exiting part 20.

In the first embodiment of the present invention, the taper structure, the stepwise structure, the relief structure and/or the discontinuous core structure provided in the optical waveguide for visible light guide 1 can be generally formed by a photolithography method, a stamping method, a pressing method, an imprinting method or a combination of the methods.

The structure of the light entering part 10 of the optical waveguide for visible light guide 1 according to the first embodiment of the present invention is not limited in any way, and not only light may be incident on the cross section on the end of the core in the coaxial direction, but also light may be incident in various directions including the upper surface, the side surface and the lower surface.

The structures where light is incident on the light entering part 10 of the optical waveguide for visible light guide 1 according to the first embodiment of the present invention will be described below with reference to FIGS. 13 to 19. In FIGS. 13 to 19, the light exiting part 20 is not shown therein since they are each a partial schematic illustration of the incident side.

FIG. 13 is a partial schematic illustration showing an example of a light entering part of an optical waveguide for visible light guide 1 according to the first embodiment of the present invention. In FIG. 13, a light source 2 is disposed on the backside of the optical waveguide for visible light guide 1, and light 3 travels from the light entering part 10 straight in the core layer 31 toward the front side.

FIGS. 14 to 19 are each a partial schematic illustration showing another example of a light entering part 10 of an optical waveguide for visible light guide 1 according to the first embodiment of the present invention. In FIG. 14, a light source 2 is disposed on the lower surface of the optical waveguide for visible light guide 1. Light 3 emitted from the light source 2 is incident on the light entering part 10 and enters into the core layer 31, is reflected by a reflection mirror 60, and travels straight in the core layer 31. The light source 2 may be disposed on the upper surface of the optical waveguide for visible light guide 1 in the similar manner. FIG. 15 shows a case where a light source 2 is disposed on the side surface of an optical waveguide for visible light guide 1. As similar to the case shown in FIG. 14, light 3 emitted from the light source 2 is incident on the light entering part 10 and enters into the core layer 31, is reflected by a reflection mirror 60, and travels straight in the core layer 31. The light source 2 may be disposed on either the right side surface or the left side surface.

FIGS. 16 and 17 each show a case where light 3 from one light source is branched into two or more directions. The branched directions and the number of the directions can be freely controlled by changing appropriately the configuration of the light reflection layer, such as a reflection mirror or a reflection film.

In FIG. 16, a light source 2 is disposed on the lower surface of the optical waveguide for visible light guide 1, and light 3 is reflected and branched by a reflection mirror 60 into two different directions, and travels straight in the core layer 31. The light 3 emitted from the light source 2 is incident on the light entering part 10 and enters into the core layer 31, is reflected by a reflection mirror 60, and travels straight in the core layer 31. The light source 2 may be disposed on the upper surface of the optical waveguide for visible light guide 1 in the similar manner. FIG. 17 shows a case where a light source 2 is disposed on the side surface of an optical waveguide for visible light guide 1. As similar to the case shown in FIG. 16, light 3 emitted from the light source 2 is incident on the light entering part 10 and enters into the core layer 31, is reflected and branched by a reflection mirror 60 into two different directions, and travels straight in the core layer 31. The light source 2 may be disposed on either the right side surface or the left side surface.

FIG. 18 shows an embodiment with a core layer 31 having a large size with respect to a light source 2, in which light 3 from a light source 2 is guided into plural directions by a core layer adjacent to a light entering part 10.

In FIG. 19, a light source 2 is disposed on the lower surface of an optical waveguide for visible light guide 1, and on the upper surface thereof, a light reflection layer 70 is provided in addition to a reflection mirror 60. Light 3 emitted from the light source 2 is incident on the light entering part 10 and enters into the core layer 31, is reflected by the reflection mirror 60 and the light reflection layer 70, and travels straight in the core layer 31. The light source 2 may be disposed on the upper surface of the optical waveguide for visible light guide 1, whereas the reflection mirror 60 and the light reflection layer 70 may be disposed on the lower surface thereof, in the similar manner. The use of the light reflection layer 70 provided not only enhances the efficiency of light entering from the light source to the waveguide, but also compensates the strength of the waveguide, which has been lowered by forming the reflection mirror 60.

The aforementioned structures of the light entering part 10 and the core layer adjacent thereto and the aforementioned structures of the light exiting part 20 and the core layer adjacent thereto may be appropriately combined and installed in the optical waveguide for visible light guide 1, thereby providing the optical waveguide for visible light guide 1 for illumination emitting light 3 with various modes.

FIGS. 20 and 21 are each a schematic illustration showing an example of a flexible optical waveguide for visible light guide 1a according to the second embodiment of the present invention. In the flexible optical waveguide for visible light guide 1a shown in FIG. 20, light 3 incident from a light source 2 on a light entering part 10 travels in an optical waveguide layer 30 and exits from a light exiting part 20 to the outside of the flexible optical waveguide for visible light guide 1a. FIG. 20 shows the case providing one light source 2, one light entering part 10 and one light exiting part 20, and as shown in FIG. 21, one light source 2, one light entering part 10 and two light exiting parts 20 may be provided. One light source 2 may be used, and plural light sources may be provided. One light entering part 10 may be used, and plural light entering parts may be provided. Further, one light exiting part 20 may be used, and plural light exiting parts may be provided. The illumination area and the illumination direction of the light can be freely designed by providing the optical waveguide layer 30 with an arbitrary shape.

The structure of the light entering part 10 of the flexible optical waveguide for visible light guide 1a according to the second embodiment of the present invention is not limited in any way, and not only light may be incident on the cross section on the end of the optical waveguide layer in the coaxial direction (i.e., light enters directly into the optical waveguide without a mirror or the like), but also light may be incident in various directions including the upper surface, the side surface and the lower surface.

The structures where light is incident on the light entering part 10 of the flexible optical waveguide for visible light guide 1a according to the second embodiment of the present invention will be described below with reference to FIGS. 22 to 27. In FIGS. 22 to 27, the light exiting part 20 is not shown therein since they are each a partial schematic illustration of the incident side.

FIG. 22 is a partial schematic illustration showing an example of a light entering part of a flexible optical waveguide for visible light guide 1a according to the second embodiment of the present invention. In FIG. 22, a light source 2 is disposed on the backside of the flexible optical waveguide for visible light guide 1a (i.e., the cross section at the end of the optical waveguide layer), and light 3 travels from the light entering part 10 straight in the optical waveguide layer 30 toward the front side.

FIGS. 23 to 27 are each a partial schematic illustration showing another example of a light entering part 10 of a flexible optical waveguide for visible light guide 1a according to the second embodiment of the present invention. In FIG. 23, a light source 2 is disposed on the lower surface of the flexible optical waveguide for visible light guide 1a. Light 3 emitted from the light source 2 is incident on the light entering part 10 and enters into the optical waveguide layer 30, is reflected by a reflection mirror 60, and travels straight in the optical waveguide layer 30. The light source 2 may be disposed on the upper surface of the flexible optical waveguide for visible light guide 1a in the similar manner. FIG. 24 shows a case where a light source 2 is disposed on the side surface of a flexible optical waveguide for visible light guide 1a. As similar to the case shown in FIG. 23, light 3 emitted from the light source 2 is incident on the light entering part 10 and enters into the optical waveguide layer 30, is reflected by a reflection mirror 60, and travels straight in the optical waveguide layer 30. The light source 2 may be disposed on either the right side surface or the left side surface.

FIGS. 25 and 26 each show a case where light 3 from one light source is branched into two or more directions. The branched directions and the number of the directions can be freely controlled by changing appropriately the configuration of the light reflection layer, such as a reflection mirror or a reflection film.

In FIG. 25, a light source 2 is disposed on the lower surface of the flexible optical waveguide for visible light guide 1a, and light 3 is reflected and branched by a reflection mirror 60 into two different directions, and travels straight in the optical waveguide layer 30. The light 3 emitted from the light source 2 is incident on the light entering part 10 and enters into the optical waveguide layer 30, is reflected by a reflection mirror 60, and travels straight in the optical waveguide layer 30. The light source 2 may be disposed on the upper surface of the flexible optical waveguide for visible light guide 1a in the similar manner. FIG. 26 shows a case where a light source 2 is disposed on the side surface of a flexible optical waveguide for visible light guide 1a. As similar to the case shown in FIG. 25, light 3 emitted from the light source 2 is incident on the light entering part 10 and enters into the optical waveguide layer 30, is reflected and branched by a reflection mirror 60 into two different directions, and travels straight in the optical waveguide layer 30. The light source 2 may be disposed on either the right side surface or the left side surface.

In FIG. 27, a light source 2 is disposed on the lower surface of a flexible optical waveguide for visible light guide 1a, and on the upper surface thereof, a light reflection layer 70 is provided in addition to a reflection mirror 60. Light 3 emitted from the light source 2 is incident on the light entering part 10 and enters into the optical waveguide layer 30, is reflected by the reflection mirror 60 and the light reflection layer 70, and travels straight in the optical waveguide layer 30. The light source 2 may be disposed on the upper surface of the flexible optical waveguide for visible light guide 1a, whereas the reflection mirror 60 and the light reflection layer 70 may be disposed on the lower surface thereof, in the similar manner. The use of the light reflection layer provided not only enhances the efficiency of light entering from the light source to the waveguide, but also compensates the strength of the waveguide, which has been lowered by forming the reflection mirror 60. Preferably, the light reflection layer 70 also serves as a reinforce layer.

Structures for emitting light to a light exiting part 20 of a flexible optical waveguide for visible light guide 1a according to the second embodiment of the present invention will be described with reference to FIGS. 28 to 31. FIGS. 28 to 31 each are a partial schematic illustration, in which a light entering part 10 is not shown therein.

FIG. 28 is a partial schematic illustration showing an example of a stepwise structure of an optical waveguide layer of a flexible optical waveguide for visible light guide 1a according to the second embodiment of the present invention. In FIG. 28, steps in the downward direction (i.e., the direction toward the lower surface) of the optical waveguide layer 30 form reflection mirrors 60 by each of the steps, and the reflection mirrors 60 totally constitutes a stepwise structure 30a. Light 3 is reflected by each of the reflection mirrors 60 in the downward direction (i.e., the direction toward the lower surface) to form plural branches of the light 3 in the downward direction (i.e., the direction toward the lower surface). In FIG. 28, the light 3 exits from the light exiting part 20 on the lower surface.

In the similar manner, steps in the horizontal direction (i.e., the direction toward the side surface) of the optical waveguide layer 30 may form reflection mirrors 60 by each of the steps, and the reflection mirrors 60 may totally constitute a stepwise structure 30a. In this case, light 3 is reflected by each of the reflection mirrors 60 in the horizontal direction (i.e., the direction toward the side surface) to form plural branches of the light 3 in the horizontal direction (i.e., the direction toward the side surface). In this case, the light 3 exits from the light exiting part 20 on the side surface.

FIGS. 29 and 30 are each a partial schematic illustration showing an example of a relief structure of an optical waveguide layer of a flexible optical waveguide for visible light guide 1a according to the second embodiment of the present invention. In FIG. 29, the optical waveguide layer 30 has a relief structure 30b on the lower surface thereof, and light 3 is diffused in the upward direction (i.e., the direction toward the upper surface) and emitted from a light exiting part 20 on the upper surface. In FIG. 30, a relief structure 30b containing numerous hemispheric shapes is present at a position facing a light exiting part of the optical waveguide layer 30 with the hemispheric surface directed upward to form a light scattering layer, and light 3 is diffused by the relief structure 30b in the upward direction (i.e., the direction toward the upper surface) and emitted from a light exiting part 20 on the upper surface.

As similar to FIGS. 29 and 30, the optical waveguide layer 30 may have a relief structure 30b on the side surface thereof or in the interior thereof on the side of the side surface, and light 3 is diffused in the horizontal direction (i.e., the direction toward the side surface) and emitted from a light exiting part 20 on the side surface.

FIG. 31 is a partial schematic illustration showing an example of a mesh structure of an optical waveguide layer of a flexible optical waveguide for visible light guide 1a according to the second embodiment of the present invention. In FIG. 31, a mesh structure 30c containing numerous grids is present at a position facing a light exiting part of the optical waveguide layer 30 with the grids directed upward to form a light scattering layer, and light 3 is diffused by the mesh structure 30c in the upward direction (i.e., the direction toward the upper surface) and emitted from a light exiting part 20 on the upper surface. The mesh structure herein is not limited to grids and may be any structure that forms a mesh.

As similar to FIG. 31, the optical waveguide layer may have a mesh structure 30c on the side surface thereof or in the interior thereof on the side of the side surface, and light 3 is diffused in the horizontal direction (i.e., the direction toward the side surface) and emitted from a light exiting part 20 on the side surface.

The flexible optical waveguide for visible light guide 1a that has various illumination patterns can be produced by providing or combining the stepwise structure 30a, the relief structure 30b and/or the mesh structure 30c mentioned above in the light entering part 10 and/or the light exiting part 20 of the optical waveguide layer 30, and/or the optical waveguide layer 30 between the light entering part 10 and the light exiting part 20.

In the second embodiment of the present invention, the stepwise structure, the relief structure and/or the mesh structure provided in the flexible optical waveguide for visible light guide 1a can be generally formed by a photolithography method, a stamping method, a pressing method, an imprinting method or a combination of the methods.

The aforementioned structures of the light entering part 10 and the optical waveguide layer adjacent thereto and the aforementioned structures of the light exiting part 20 and the optical waveguide layer adjacent thereto may be appropriately combined and installed in the flexible optical waveguide for visible light guide 1a, thereby providing the flexible optical waveguide for visible light guide 1a for illumination emitting light 3 with various modes.

The material used in the core layer 31 of the optical waveguide for visible light guide 1 according to the first embodiment of the present invention and the optical waveguide layer 30 of the flexible optical waveguide for visible light guide 1a according to the second embodiment of the present invention is not particularly limited as far as it is a transparent material and has a refractive index that is higher than the cladding layer in the first embodiment or higher than the air in the second embodiment, and a thermosetting resin, a thermoplastic resin, a photocurable resin and the like may be used, specific examples of which include a (meth)acrylic resin (the (meth)acrylic resin herein means an acrylic resin or a methacrylic resin), a styrene resin, a vinyl resin, an olefin resin, an alicyclic polyolefin resin, a phenol resin, a phenoxy resin, an epoxy resin, a urethane resin, a polyamide resin, a polyester resin, a polyesteramide resin, a polyether resin, a urea resin, a polythioether resin, a polythiourea resin, a silicone resin, a polyetheramide resin, a polyimide resin, a polyamideimide resin and a polycarbonate resin. Two or more kinds of these resins may be used unless transparency is impaired, and monomers constituting the aforementioned resins may be used in combination, such as a (meth)acrylate monomer, a vinyl monomer, a diol compound, a carboxylic acid, a carboxylic anhydride, an amine compound, an isocyanate compound and a silane compound. Among these, a (meth)acrylic resin, a vinyl resin, an olefin resin, an alicyclic polyolefin resin, a phenoxy resin, an epoxy resin, a polythioether resin, a polycarbonate resin, a silicone resin and the like are preferred owing to excellent transparency thereof.

The material used in the cladding layer 40 of the optical waveguide for visible light guide 1 according to the first embodiment of the present invention is not particularly limited as far as it is a material having a refractive index that is lower than the core layer, and may not be necessarily transparent. However, it is preferred for workability that the material is approximately translucent upon subjecting to a cutting operation or the like. The cladding layer 40 that is translucent may exhibit an effect of diffusing light in some cases.

As the material used in the cladding layer 40, a thermosetting resin, a thermoplastic resin, a photocurable resin and the like may be used, specific examples of which include a (meth)acrylic resin, a styrene resin, a vinyl resin, an olefin resin, an alicyclic polyolefin resin, a phenol resin, a phenoxy resin, an epoxy resin, a urethane resin, a polyamide resin, a polyester resin, a polyesteramide resin, a polyether resin, a urea resin, a polythioether resin, a polythiourea resin, a silicone resin, a polyetheramide resin, a polyimide resin, a polyamideimide resin and a polycarbonate resin. Two or more kinds of these resins may be used, and monomers constituting the aforementioned resins may be used in combination, such as a (meth)acrylate monomer, a vinyl monomer, a diol compound, a carboxylic acid, a carboxylic anhydride, an amine compound, an isocyanate compound and a silane compound. Furthermore, an elastomer and/or an inorganic filler may be used depending on necessity for diffusing light and for enhancing toughness of the resin.

The elastomer herein is not particularly limited as far as it is a material having a glass transition temperature that is around or lower than room temperature, and examples thereof include a silicone resin, a (meth)acrylic resin, an ethylene-propylene copolymer, a styrene-(meth)acrylic copolymer, polybutadiene, polyisoprene and a urethane resin.

As the inorganic filler referred herein, a fibrous inorganic filler, a sheet-shaped inorganic filler, a spherical inorganic filler, a fibrous organic filler, a sheet-shaped organic filler and the like may be used. Examples of the fibrous inorganic filler and the sheet-shaped inorganic filler include glass fibers, microglass fibers, pitch carbon fibers, polyacrylonitrile carbon fibers, active carbon fibers, sepiolite fibers, potassium titanate fibers, ceramic fibers, wollastonite fibers, rock wool, and a sheet formed of these materials. Examples of the spherical inorganic filler include silica, alumina, titanium oxide, barium titanate, calcium carbonate, magnesium carbonate, carbon, clay, silicon carbide, talc, aluminum silicate, magnesium silicate, mica, calcium hydroxide and barium sulfate. Examples of the fibrous organic filler and the sheet-shaped organic filler include aramid fibers, a sheet formed of aramid fibers, polyester fibers and a sheet formed of polyester fibers. The fillers may be used solely or in combination of plural kinds thereof.

The optical waveguide for visible light guide 1 according to the first embodiment of the present invention may have, depending on necessity, in addition to the reflection mirror 60 or instead of the reflection mirror, a light reflection layer adjacent to a part of the cladding layer. The flexible optical waveguide for visible light guide 1a according to the second embodiment of the present invention may have, depending on necessity, in addition to the reflection mirror 60 or instead of the reflection mirror, a light reflection layer covering at least a part of the optical waveguide layer 30. According to the structure, the traveling direction of the light 3 can be changed, and the light 3 can be branched. As the light reflection layer, a metal may be vapor-deposited on the reflection surface, a reflection film or a metallic foil may be adhered thereto, or a coating material containing a sheet-shaped inorganic filler may be coated thereon. Furthermore, these, may be adhered for serving also reinforcement.

The reflection mirror 60 and the light reflection layer are preferably provided in combination for enhancing the reflection efficiency.

FIG. 32 is a partial schematic illustration showing an example of a flexible optical waveguide for visible light guide 1a according to the second embodiment of the present invention, in which the upper surface and the lower surface of the optical waveguide layer 30 except for the light exiting part 20 are covered with a light reflection layer 70, and FIG. 33 is a partial schematic illustration showing the flexible optical waveguide for visible light guide 1a, in which the circled area in FIG. 32 is enlarged. By covering the non-light exiting part except for the light entering part 10 and the light exiting part 20 with the light reflection layer 70, the reflection efficiency at the interface with the optical waveguide layer 30 is enhanced, and the light 3 is emitted with the relief structure 30b from the light exiting part.

The optical waveguide for visible light guide 1 according to the first embodiment of the present invention may have, depending on necessity, a light scattering layer adjacent to the light exiting part of the optical waveguide for visible light guide. The light scattering layer is formed by providing a diffraction grating or a hemispheric relief as shown in FIG. 12 or adding fine particles having a diameter of from 0.05 to 100 μm, preferably from 0.1 to 5 μm, and particularly preferably from 0.1 to 1.0 μm, to the core layer 31 or the cladding layer 40.

The flexible optical waveguide for visible light guide 1a according to the second embodiment of the present invention may have, depending on necessity, as a structure scattering light adjacent to the light exiting part of the flexible optical waveguide for visible light guide, in addition to the relief structure or the mesh structure or instead of the relief structure or the mesh structure, a light scattering layer formed by adding fine particles having a diameter of from 0.05 to 100 μm, preferably from 0.1 to 5 μm, and particularly preferably from 0.1 to 1.0 μm, to the portion adjacent to the light exiting part of the optical waveguide layer 30.

Examples of the fine particles used include inorganic fine particles, such as titanium oxide, glass beads, magnesia, barium sulfate, silica, calcium carbonate and zirconia oxide, and polymer fine particles, such as polystyrene, polyacrylate, polymethacrylate, polyvinyl acetate, polyurethane, polyurea, polyimide, polyimide, polyester and silicone. The fine particles preferably has a spherical shape. With fine particles having an acicular shape or a sheet-shaped shape, the fine particles may not be suitably irradiated with the incident light, the angles of the scattered light may be biased, and the scattered light may be shielded by the other particles, whereby the intensity of the scattered light may be lowered.

The optical waveguide for visible light guide 1 according to the first embodiment of the present invention may further have, depending on necessity, at least one selected from a diverging lens, a converging lens, a prism and a reflection mirror, adjacent to the light entering part and/or the light exiting part of the optical waveguide for visible light guide. Furthermore, the optical waveguide for visible light guide may have, depending on necessity, at least one selected from a colored layer formed of a colored (resin) film or the like, a color filter, a polarizing filter and a coating layer containing a dye or a pigment, adjacent to the light entering part and/or the light exiting part thereof. The use of a colored film, a color filter or a coating layer containing a dye or a pigment provided adjacent to the light entering part 10 and/or the light exiting part 20 of the optical waveguide for visible light guide 1 can change the light 3 emitted to desired color, and the light 3 can be converted to polarized light by passing through a polarizing filter.

The flexible optical waveguide for visible light guide 1a according to the second embodiment of the present invention may have, depending on necessity, at least one selected from a reflection mirror, a colored layer, a diverging lens, a converging lens, a prism and a polarizing filter, in at least a part of the flexible optical waveguide for visible light guide, particularly at a position adjacent to the light entering part and/or the light exiting part or in the light entering part and/or the light exiting part.

The light 3 can be diffused or focused with a diverging lens, a converging lens or the like. The light 3 can be deflected, branched, reflected or the like with a prism, and the light 3 can be reflected with a reflection mirror described in the foregoing.

The diverging lens, the converging lens, the prism and the reflection mirror 60 used in the present invention may be formed by directly cutting or may be formed by a pressing method, a stamping method, an imprinting method, a photolithography method or the like. These may also be formed by adhering to or embedding in the waveguide a diverging lens, a converging lens, a prism or a lens array thereof, which is formed by an injection molding method, a pressing method, a stamping method, an imprinting method, a photolithography method, an ink-jet method, a casting method or the like.

The light 3 having various colors can be emitted by attaching or the like a colored layer formed of a colored (resin) film or the like to the light entering part and/or the light exiting part. Unnecessary reflected light and polarized component can be removed from the light by attaching or the like a polarizing filter to the light entering part and/or the light exiting part.

FIG. 34 is a partial schematic illustration showing an example of a flexible optical waveguide for visible light guide 1a according to the second embodiment of the present invention, in which the circled area in FIG. 32 is enlarged. A colored layer 50 is attached or the like to the light exiting part, thereby emitting light 3 with desired color.

The flexible optical waveguide for visible light guide 1a according to the second embodiment of the present invention may further have, depending on necessity, for protecting the optical waveguide layer, a protective layer covering at least a part of the optical waveguide layer 30. This is because when the flexible optical waveguide is damaged or the like, the possibility arises that light is leaked from the portion other than the light exiting part. A protective layer having high transparency and high scratch resistance may be disposed at the light entering part or the light exiting part for maintaining the transparency of the light entering part or the light exiting part. The protective layer preferably functions as the light reflection layer, the colored layer, the polarizing filter or the like, for suppressing the thickness of the flexible optical waveguide for visible light guide 1a.

Examples of the material for the protective layer include an organic material, such as polyolefin, polycycloolefin, polyvinyl halide, polystyrene, polyacrylate, polymethacrylate, polyester, liquid crystalline polyester, unsaturated polyester, polyamide, polyimide, polyamideimide, polyesterimide, polyurethane, an epoxy resin, a phenoxy resin, a phenol resin, a urea resin and a silicone resin, and a metallic material, such as gold, silver, copper and aluminum. These material may be used in combination of two or more kinds thereof.

### Example

The present invention will be described in more detail with reference to examples below, but is not limited in any way by the examples.

### Production of (Meth)acrylic Polymer (A) for Binder

150 parts by mass of propylene glycol monomethyl ether acetate and 30 parts by mass of methyl lactate were weighted in a flask equipped with a stirrer, a condenser, a gas introducing tube, a dropping funnel and a thermometer, and were started to be stirred with nitrogen gas introduced. The liquid temperature was increased to 80° C., and 20 parts by mass of N-cyclohexylmaleimide, 40 parts by mass of dicyclopentadienyl methacrylate, 25 parts by mass of 2-ethylhexyl methacrylate, 15 parts by mass of methacrylic acid and 3 parts by mass of 2,2′-azobis(isobutyronitrile) were added dropwise thereto, followed by stirring continuously at 80° C. for 6 hours, thereby providing a (meth)acrylic polymer P-1 solution (solid content: 36% by mass).

168 parts by mass (solid content: 60 parts by mass) of the P-1 solution (solid content: 36% by mass), 0.03 part by mass of dibutyltin dilaurate and 0.1 part by mass of p-methoxyphenol were weighed in a flask equipped with a stirrer, a condenser, a gas introducing tube, a dropping funnel and a thermometer, and were started to be stirred with the air introduced. The liquid temperature was increased to 60° C., and 7 parts by mass of 2-methacryloyloxyethylisocyanate was added dropwise thereto over 30 minutes, followed by stirring at 60° C. for 4 hours, thereby providing a polymer solution for binder (A) (solid content: 40% by mass).

### Measurement of Acid Value

The result of measurement of the acid value of (A) was 98 mgKOH/g. The acid value was calculated from the amount of a 0.1 mol/L potassium hydroxide aqueous solution that was required for neutralizing P-1. The point where phenolphthalein added as an indicator was changed from colorless to pink color was designated as the neutralization point.

### Preparation of Resin Varnish CO-1 for forming Core Part

168 parts by mass (solid content: 60 parts by mass) of (A) (solid content: 36% by mass), 20 parts by mass of ethoxylated bisphenol A diacrylate (A-BPE-6, produced by Shin-Nakamura Chemical Co., Ltd.), 20 parts by mass of p-cumylphenoxyethyl acrylate (A-CMP-1E, produced by Shin-Nakamura Chemical Co., Ltd.) and 2 parts by mass of a mixture of 2-(2-oxo-2-phenylacetoxyethoxy)ethyl oxyphenylacetate ester and 2-(2-hydroxyethoxy)ethyl oxyphenylacetate ester (Irgacure 754, produced by Ciba Specialty Chemicals Co., Ltd.) were weighed in a wide mouthed polymer bottle, and stirred with a stirrer under conditions of a temperature of 25° C. and a rotation number of 400 rpm for 6 hours, thereby preparing a resin varnish for forming a core part. Thereafter, it was filtered under pressure with Polyflon Filter having a pore diameter of 2 μm (PF020, produced by Advantech Toyo Co., Ltd.) and a membrane filter having a pore size of 0.5 μm (J050A, produced by Advantech Toyo Co., Ltd.) under conditions of a temperature of 25° C. and a pressure of 0.4 MPa. Subsequently, it was defoamed with a vacuum pump and a bell jar under conditions of a depressurizing degree of 50 mmHg for 15 minutes, thereby providing a resin varnish CO-1 for forming a core part.

Production of Resin Film COF-1 for forming Optical Waveguide Layer or Core Part

The resin varnish CO-1 for forming a core part was coated on an untreated surface of a PET film (A1517, produced by Toyobo Co., Ltd., thickness: 16 μm) with a coating machine (Multi Coater TM-MC, produced by Hirano Tecseed Co., Ltd.) and dried at 100° C. for 20 minutes, to which a releasable PET film (A31, produced by Teijin DuPont Films Japan, Ltd., thickness: 25 μm) as a protective film was then attached, thereby providing a resin film COF-1 for forming an optical waveguide layer or a core part. The thickness of the resin layer was able to control arbitrarily by changing the gap of the coating machine, and it was controlled to provide a thickness of the film after curing of 100 μm in this example.

Preparation of Resin Varnish CL-1 for forming Cladding Layer

168 parts by mass (solid content: 60 parts by mass) of (A) (solid content: 36% by mass), 20 parts by mass of ethoxylated cyclohexanedimethanol diacrylate (A-CHD-4E, produced by Shin-Nakamura Chemical Co., Ltd.), 20 parts by mass of ethoxylated isocyanuric acid triacrylate (A-9300, produced by Shin-Nakamura Chemical Co., Ltd.), 1 part by mass of 1-(4-(2-hydroxyethoxy)phenyl)-2-hydroxy-2-methyl-1-propan-1-one (Irgacure 2959, produced by Ciba Specialty Chemicals Co., Ltd.) and 1 part by mass of bis(2,4,6-trimethylbenzoyl)phenylphosfine oxide (Irgacure 819, produced by Ciba Specialty Chemicals Co., Ltd.) were weighed in a wide mouthed polymer bottle, and stirred with a stirrer under conditions of a temperature of 25° C. and a rotation number of 400 rpm for 6 hours, thereby preparing a resin varnish for forming a cladding part. Thereafter, it was filtered under pressure with Polyflon Filter having a pore diameter of 2 μm (PF020, produced by Advantech Toyo Co., Ltd.) and a membrane filter having a pore size of 0.5 μm (J050A, produced by Advantech Toyo Co., Ltd.) under conditions of a temperature of 25° C. and a pressure of 0.4 MPa. Subsequently, it was defoamed with a vacuum pump and a bell jar under conditions of a depressurizing degree of 50 mmHg for 15 minutes, thereby providing a resin varnish CL-1 for forming a cladding part.

Production of Resin Film CLF-1 for forming Lower Cladding Layer

The resin varnish CL-1 for forming a cladding layer was coated on an untreated surface of a PET film (A4100, produced by Toyobo Co., Ltd., thickness: 50 μm) in the same manner as the resin film for forming a core layer, thereby providing a resin film CLF-1 for forming a cladding layer. The thickness of the resin layer was able to control arbitrarily by changing the gap of the coating machine, and it was controlled to provide a thickness of the film after curing of 25 μm in this example.

Production of Resin Film CLF-2 for forming Upper Cladding Layer

The resin varnish CL-1 for forming a cladding layer was coated on an untreated surface of a PET film (A1517, produced by Toyobo Co., Ltd., thickness: 16 μm) in the same manner as the resin film for forming a core layer, thereby providing a resin film CLF-1 for forming a cladding layer. The thickness of the resin layer was able to control arbitrarily by changing the gap of the coating machine, and it was controlled to provide a thickness of the film after curing of 70 μm in this example.

Two sheets of the coated film, from each of which the protective film (A31) had been removed, were adhered to each other and laminated under conditions of a pressure of 0.2 MPa, a temperature of 50° C. and a pressurizing time of 30 seconds, with a vacuum pressurizing laminating machine, thereby providing a resin film (CLF-2) having a film thickness of 140 μm for forming an upper cladding.

### Production of Optical Waveguide for Visible Light Guide

### Example 1

The resin film CLF-1 for forming a lower cladding layer was irradiated with an ultraviolet ray (wavelength: 365 nm) at 2,000 mJ/cm² with an ultraviolet ray exposure machine (MAP-1200-L, produced by Dainippon Screen Mfg. Co., Ltd.), and then the substrate film (A1517) was removed. Separately, the film for forming a core layer was punched out with a die having an arbitrary shape along with the protective film (A31) and the PET film (A1517), thereby preparing a core pattern. The protective film (A31) was removed from the core film thus punched out, which was then attached to the cured CLF-1 film with a vacuum pressurizing laminating machine. Thereafter, the core layer was irradiated with an ultraviolet ray (wavelength: 365 nm) at 2,000 mJ/cm² with an ultraviolet ray exposure machine and further subjected to a heat treatment at 80° C. for 10 minutes, and then the substrate film (A1517) was removed.

The resin film CLF-2 for forming an upper cladding layer, from which the protective film (A31) had been removed, was laminated on core part and the lower cladding layer under conditions of a pressure of 0.5 MPa, a temperature of 50° C. and a pressurizing time of 30 seconds, with a vacuum pressurizing laminating machine. The laminated assembly was irradiated with an ultraviolet ray (wavelength; 365 nm) at 2,000 mJ/cm², and after removing the substrate film (A1517), was subjected to a heat treatment at 120° C. for 1 hour to form an upper cladding layer, thereby providing an optical waveguide for visible light guide. Thereafter, a light entering part and a light exiting part were obtained by cutting with a dicing saw (DAD-341, produced by Disco Corporation), thereby producing an optical waveguide for visible light guide shown in FIG. 6. The light exiting part had an area of 2.4 mm².

### Example 2

The resin film CLF-1 for forming a lower cladding layer was irradiated with an ultraviolet ray (wavelength: 365 nm) at 2,000 mJ/cm² with an ultraviolet ray exposure machine (MAP-1200-L, produced by Dainippon Screen Mfg. Co., Ltd.), and then the substrate film (A1517) was removed.

Separately, the film for forming a core layer was punched out with a die having an arbitrary shape along with the protective film (A31) and the PET film (A1517), thereby preparing a core pattern. The protective film (A31) was removed from the core film thus punched out, which was then attached to the cured CLF-0.1 film with a vacuum pressurizing laminating machine. Thereafter, the core layer was irradiated with an ultraviolet ray (wavelength: 365 nm) at 2,000 mJ/cm² with an ultraviolet ray exposure machine and further subjected to a heat treatment at 80° C. for 10 minutes, and then the substrate film (A1517) was removed. The film was then heated to 120° C., and the light exiting part of the core layer was embossed by a stamping method.

The resin film CLF-2 for forming an upper cladding layer, from which the protective film (A31) had been removed, was laminated on core part and the lower cladding layer under conditions of a pressure of 0.5 MPa, a temperature of 50° C. and a pressurizing time of 30 seconds, with a vacuum pressurizing laminating machine. The laminated assembly was irradiated with an ultraviolet ray (wavelength: 365 nm) at 2,000 mJ/cm², and after removing the substrate film (A1517), was subjected to a heat treatment at 120° C. for 1 hour to form an upper cladding layer, thereby providing an optical waveguide for visible light guide. Thereafter, a light entering part and a light exiting part were obtained by cutting with a dicing saw (DAD-341, produced by Disco Corporation), thereby producing an optical waveguide for visible light guide shown in FIG. 10. The light exiting part had an emission area of 10 mm².

### Examples 3 to 11

Optical waveguides for visible light guide (Examples 3 to 10) shown in FIGS. 2 to 5, 7, 8, 11 and 12 were produced in the same manner as in Example 1. An optical waveguide for visible light guide (Example 11) shown in FIG. 9 was produced in the same manner as in Example 2. The emission area upon emitting light was 1.6 mm² in Examples 3 to 6 shown in FIGS. 2 to 5, 3.2 mm² in Examples 7 and 8 shown in FIGS. 7 and 8, and 10 mm² in Examples 9 and 10 shown in FIGS. 11 and 12, and was 8 mm² in Example 11 shown in FIG. 9.

### Example 12

An optical waveguide shown in FIG. 35 was produced in the same manner as in Example 1. The light exiting part had an area of 2 mm². Light emitted from a white LED, which was in direct contact with the light entering part of the optical waveguide, was guided, and the light emission spectrum of the incident light (i.e., the spectrum of the light emitted from the white LED) and the light emission spectrum of the emission light (i.e., the spectrum of the light emitted from the light exiting part) were measured with a multiple photometry system (MCPD-3000, a trade name, produced by Otsuka Electronics Co., Ltd.). FIG. 36 is a schematic illustration showing the measurement results. From the light emission spectra of the incident light and the emission light thus measured, the light emission intensities of the maximum peak in a wavelength range of from 420 to 500 nm were 4.08 for the incident light and 2.15 for the emission light, and thus the light emission intensity ratio (incident light peak intensity)/(emission light peak intensity) was 1/0.53.

All the optical waveguides for visible light guide of Examples 1 to 12 were able to be reduced in size and formed or the like on a substrate, and thus were favorably used for illumination.

### Production of Flexible Optical Waveguide for Visible Light Guide

### Example 13

The film for forming an optical waveguide layer was punched out with a die having an arbitrary shape along with the protective film (A31) and the PET film (A1517), thereby preparing a core pattern. Thereafter, the film was irradiated with an ultraviolet ray (wavelength: 365 nm) at 2,000 mJ/cm² with an ultraviolet ray exposure machine with an ultraviolet ray exposure machine (MAP-1200-L, produced by Dainippon Screen Mfg. Co., Ltd.) and further subjected to a heat treatment at 80° C. for 10 minutes. The protective film (A31) and the substrate film (A1517) were removed from the core film punched out, thereby providing a flexible optical waveguide for visible light guide shown in FIG. 28. A copper foil 70a having a thickness of 9 μm (functioning as both a light reflection layer and a protective layer) was attached to the upper surface and the lower surface of the optical waveguide layer other than the light entering part and the light exiting part. The flexible optical waveguide thus obtained had a length of 100 mm, a width of 2 mm and a thickness of 118 μm, and the ratio length/width of the flexible optical waveguide was 50. The light exiting part had an area of 0.2 mm².

### Example 14

The protective film (A31) at the light exiting part of the film for forming an optical waveguide was peeled, and a silicone mold having an arbitrary shape formed thereon was pressed onto the light exiting part at a temperature of 60° C. and a pressure of 0.4 MPa for 30 seconds. The optical waveguide layer was irradiated in that state with an ultraviolet ray (wavelength: 365 nm) at 2,000 mJ/cm² from the side of the PET film with an ultraviolet ray exposure machine and further subjected to a heat treatment at 80° C. for 10 minutes. Thereafter, the silicone mold, the remaining protective film (A31) and the substrate film (A1517) were removed. Thereafter, the optical waveguide was cut out to have a width of 1 mm with the aforementioned dicing saw, thereby producing a flexible optical waveguide for visible light guide shown in FIG. 30. A copper foil 70a having a thickness of 9 μm (functioning as both a light reflection layer and a protective layer) was attached to the upper surface and the lower surface of the optical waveguide layer other than the light entering part and the light exiting part. FIG. 37 is a schematic illustration showing the flexible optical waveguide for visible light guide produced in Example 14. The flexible optical waveguide for visible light guide thus obtained had a length of 100 mm, a width of 1 mm and a thickness of 118 μm, and the ratio length/width of the flexible optical waveguide was 100. The light exiting part had an area of 50 mm².

Light emitted from a white LED at the light entering part of the optical waveguide was guided, and the light emission spectrum of the incident light (i.e., the spectrum of the light emitted from the white LED) and the light emission spectrum of the emission light (i.e., the spectrum of the light emitted from the light exiting part) were measured with a multiple photometry system (MCPD-3000, a trade name, produced by Otsuka Electronics Co., Ltd.). FIG. 36 is a schematic illustration showing the measurement results. From the light emission spectra of the incident light and the emission light thus measured, the light emission intensities of the maximum peak in a wavelength range of from 420 to 500 nm were 4.12 for the incident light and 2.17 for the emission light, and thus the light emission intensity ratio (incident light peak intensity)/(emission light peak intensity) was 1/0.527.

### Examples 15 and 16

Flexible optical waveguides for visible light guide (Examples 15 and 16) shown in FIGS. 29 and 31 were produced in the same manner as in Example 14. The flexible optical waveguide of Example 15 had a length of 100 mm, a width of 1 mm and a thickness of 118 μm, and the ratio length/width of the flexible optical waveguide was 100, the flexible optical waveguide of Example 16 had a length of 100 mm, a width of 1 mm and a thickness of 118 μm, and the ratio length/width of the flexible optical waveguide was 100.

The light emission areas emitting light were 50 mm² in Example 15 shown in FIGS. 29 and 50 mm² in Example 16 shown in FIG. 31.

All the flexible optical waveguides for visible light guide of Examples 13 to 16 were able to be reduced in size and formed or the like on a substrate, and thus were favorably used for illumination.

### INDUSTRIAL APPLICABILITY

The optical waveguide for visible light guide of the present invention has a planar structure, can be reduced in size and increased in density, and can be formed or the like on a substrate, and the flexible optical waveguide for visible light guide of the present invention can be easily reduced in width and thickness, is flexible to enable use in a bent state, and can be installed in a small gap in a small-sized electronic apparatus, which can be favorably applied to illumination and light indication of various kinds of small-sized electronic apparatuses.

1. An optical waveguide for visible light guide comprising an optical waveguide layer, at least one light entering part and at least one light exiting part, the light entering part and the light exiting part being disposed not adjacent to each other.

2. The optical waveguide for visible light guide according to claim 1, wherein the optical waveguide layer has a core layer that is partially or entirely covered with a cladding layer, and has at least one selected from a taper structure, a stepwise structure, a relief structure and a discontinuous core structure with the core layer as a structure for emitting light to the light exiting part.

3. The optical waveguide for visible light guide according to claim 1, which is a flexible optical waveguide in a strip form.

4. The optical waveguide for visible light guide according to claim 1, wherein the core layer has a thickness of from 0.05 to 2.0 mm.

5. The optical waveguide for visible light guide according to claim 1, which further comprises a light reflection layer adjacent to a part of the cladding layer.

6. The optical waveguide for visible light guide according to claim 1, which further comprises a light scattering layer adjacent to the light exiting part.

7. The optical waveguide for visible light guide according to claim 1, which further comprises at least one selected from a diverging lens, a converging lens, a prism and a reflection mirror, adjacent to the light entering part and/or the light exiting part.

8. The optical waveguide for visible light guide according to claim 1, which further comprises at least one selected from a colored film, a color filter, a polarizing filter and a coating layer containing a dye or a pigment, adjacent to the light entering part and/or the light exiting part.

9. The optical waveguide for visible light guide according to claim 3, wherein the total area of the light exiting part is 70% or less of the total area of a surface that has the maximum surface area of the optical waveguide.

10. The optical waveguide for visible light guide according to claim 3, wherein the optical waveguide layer has at least one selected from a stepwise structure, a relief structure and a mesh structure, as a structure for emitting light to the light exiting part.

11. The optical waveguide for visible light guide according to claim 3, wherein the light entering part and the light exiting part are disposed on the same surface or opposing surfaces of the optical waveguide layer.

12. The optical waveguide for visible light guide according to claim 3, wherein one of the light entering part and the light exiting part is disposed on a side surface of the optical waveguide layer, and the other is disposed on an upper surface or a lower surface of the optical waveguide layer.

13. The optical waveguide for visible light guide according to claim 3, wherein the optical waveguide has a ratio length/width of from 10 to 50,000.

14. The optical waveguide for visible light guide according to claim 3, wherein the optical waveguide has a length of from 10 to 500 mm.

15. The optical waveguide for visible light guide according to claim 3, wherein the optical waveguide has a width of from 0.01 to 5 mm.

16. The optical waveguide for visible light guide according to claim 3, wherein the optical waveguide has a thickness of from 10 to 500 μm.

17. The optical waveguide for visible light guide according to claim 3, which further comprises a light reflection layer covering at least a part of the optical waveguide layer.

18. The optical waveguide for visible light guide according to claim 3, which further comprises a protective layer covering at least a part of the optical waveguide layer.

19. The optical waveguide for visible light guide according to claim 3, which further comprises at least one selected from a reflection mirror, a colored layer, a diverging lens, a converging lens, a prism and a polarizing filter.

20. The optical waveguide for visible light guide according to claim 3, which has a structure where at least a part of the light exiting part is bent.

21. The optical waveguide according to claim 1, which is capable of guiding light having a wavelength of from 350 to 800 nm.

22. The optical waveguide for visible light guide according to claim 1, which is an optical waveguide for guiding light having a wavelength of from 350 to 800 nm, in which a light emission intensity ratio of the maximum peak in a light emission spectrum in a wavelength range of from 420 to 500 nm between incident light and emission light has a relationship (incident light peak intensity)/(emission light peak intensity)=1/1 to 1/0.3.

23. The optical waveguide for visible light guide according to claim 1, wherein the light exiting part has an area of from 0.0025 to 100 mm².
